(19) United States
(12) Patent Application Publication
(10) Pub. No.: US 2025/0160411 A1
(43) Pub. Date: May 22, 2025

(54) Heating Apparatus for an Aerosol Generating Device

(71) Applicant: JT INTERNATIONAL SA, Geneva (CH)

(72) Inventor: Eduardo Jose Garcia Garcia, Grand-Saconnex (CH)

(73) Assignee: JT INTERNATIONAL SA, Geneva (CH)

(21) Appl. No.: 18/833,181

(22) PCT Filed: Jan. 30, 2023
(86) PCT No.: PCT/EP2023/052168

§ 371 Date: Jul. 25, 2024

(30) Foreign Application Priority Data
Jan. 31, 2022 (EP) 22154348.1

(51) Int. Cl. A24F 40/46; A24D 1/20; A24F 40/20; H05B 3/48

(52) U.S. Cl. CPC A24F 40/46; A24D 1/20; A24F 40/20; H05B 3/48

(57) ABSTRACT

A heating apparatus for an aerosol generating device includes: a cavity having a main longitudinal axis and including an opening in which an aerosol forming substance can be received; a first insulator sleeve including an inner wall and an outer wall, where the inner wall is radially proximal to the cavity, the first insulator sleeve arranged along a first portion of the cavity with respect to the axis; a second insulator including an inner wall and an outer wall, where the inner wall is radially proximal to the cavity, the second insulator arranged along a second portion of the cavity, wherein the second portion is positioned distally to the opening with respect to the first insulator sleeve along the axis; and a heater positioned radially inwardly with respect to the outer wall of the second insulator and configured to provide heat to an aerosol forming substance received in the cavity.

### FIELD OF THE INVENTION

The present invention relates to a heating apparatus for an aerosol generating device and an aerosol generating device comprising a heating apparatus. The disclosure is particularly applicable to a portable aerosol generating device, which may be self-contained and low temperature. In particular, the invention relates to an aerosol generating device with a heater disposed within a vacuum or insulator chamber.

### BACKGROUND

It is a developing field of interest to produce electronic cigarettes that heat, but do not burn, a solid or semi-solid aerosol forming substrate which comprises tobacco. These devices typically receive a rod of tobacco in a heating chamber. The rod is heated to release aerosol which can be inhaled by a user. One issue in these devices is that the heater which supplies heat to the heating chamber can also undesirably heat the remainder of the device. In compact devices this can be disadvantageous because the temperature of the outer surfaces of the device, which are held by a user, can become unacceptably high. In order to mitigate these effects some aerosol generating devices have been provided with vacuum chambers that can space the heater from the outer surfaces. This can provide thermal separation between the heating chamber and the outer surfaces which are held by a user.

Within such aerosol generating devices, it is desirable to improve the efficiency of the heating operation such that the battery life of the device may be extended. To this end, vacuum insulators have been implemented within aerosol generating devices in order to thermally insulate the cavity in which an aerosol substrate is heated, thereby limiting thermal losses to the external environment.

An object of the present invention is to further improve the heating efficiency and reduce undesired heat loss.

### SUMMARY OF THE INVENTION

According to an aspect of the invention, there is provided a heating apparatus for an aerosol generating device, comprising: a cavity having a main longitudinal axis and comprising an opening in which an aerosol forming substance can be received; a first insulator sleeve comprising an inner wall and an outer wall, where the inner wall is radially proximal to the cavity, the first insulator sleeve arranged along a first portion of the cavity with respect to the main longitudinal axis; a second insulator comprising an inner wall and an outer wall, where the inner wall is radially proximal to the cavity, the second insulator arranged along a second portion of the cavity, wherein the second portion is positioned distally to the opening with respect to the first insulator sleeve along the main longitudinal axis; and a heater positioned radially inwardly with respect to the outer wall of the second insulator and configured to provide heat to an aerosol forming substance received in the cavity.

In this way the first insulator sleeve provides an insulating region or length (i.e. a space or gap) between the upper end of the heating area (end of the heater toward the opening of the cavity) or second portion and the opening of the cavity, or the outer surface of an aerosol generating device in which the heating apparatus is provided. This can advantageously reduce the temperature of the heating device at the position of the opening.

The first insulator sleeve and the second insulator may be regarded as dual-walled insulators in that they each have respective inner and outer walls and are configured to prevent heat transfer or heat loss from the cavity (proximal to the inner walls) to the respective outer walls.

Positioning the heater at a deeper position within the cavity effectively shortens the heating area as well as providing the heating area away from the opening of the cavity. It has been advantageously found that a smaller/shorter heating area (or heater cup mass) in a heating apparatus can improve the heat-up time of the heater and reduces energy consumption.

Preferably, the first insulator sleeve and/or the second insulator comprises a vacuum between the respective inner and outer walls. For example, the first insulator sleeve may be a vacuum insulator sleeve. The second insulator may be a second vacuum insulator.

Alternatively, the first insulator sleeve and/or the second insulator may comprise an insulating material between the respective inner and outer walls. For example, the first insulator sleeve may comprise an aerogel material between its inner and outer walls. The second insulator may comprise air between its inner and outer walls. Examples of insulating materials include, but are not limited to: air, aerogel materials, powders or fibrous insulating materials.

Preferably, the first insulator sleeve comprises a length of at least 3 millimetres (mm) along the main longitudinal axis. The length may be greater than 3 mm, for example, 5 mm, 10 mm, 15 mm, 20 mm or more. As will be appreciated, the greater the length, the deeper the heater is positioned in the cavity.

The first insulator sleeve may be arranged at the opening or slightly spaced from the opening to define a first portion of the cavity along the main longitudinal axis, and the heater may be positioned along the main longitudinal axis at a position that is at least partially offset with respect to the insulator sleeve. In one arrangement the end of the sleeve may be arranged proximal to the opening. It should be appreciated that when the heating apparatus is provided in an aerosol generating device, the opening of the heating apparatus cavity in which an aerosol forming substance is inserted may be displaced from the outer surface of the aerosol generating device, for example due to a device casing, or even a casing for the heating apparatus itself.

The second insulator surrounding the second portion of the cavity is positioned at least partially separate to the first portion along the main longitudinal axis. This ensures that there is an effective discontinuity for any heat transfer from the second insulator to the first portion/insulator sleeve. The inner wall of the second insulator may comprise a metallic surface to allow effective heat transfer from the heater to the cavity. Providing a discontinuity between the second insulator and the first insulator sleeve ensures that heat generation and transfer is effectively controlled in the second portion of the cavity. The first insulator sleeve may comprise an outer casing that is made of a non-metallic, insulation material. This further prevents heat transfer via conduction between the first insulator and the second insulator and/or heater.

Preferably, the heater is arranged on the inner wall of the second insulator, between the inner and outer walls of the second insulator. Preferably, the heating apparatus further comprises an electrical insulation layer provided between the heater and the inner wall. In this way, the safety of the device may be increased, as electrical conduction to other components of the heating apparatus or the aerosol generating device may be avoided. The electrical insulation layer could be provided as a layer of material deposited on the internal wall. Alternatively, the layer could be provided as a partial or full coating on the heater.

Preferably, the second insulator defines or is provided in the second portion of the cavity, where the second portion comprises an end of the cavity. In this way the second insulator provides an end of the cavity for a received aerosol forming consumable to abut against. The end may be a closed end of the cavity such that there is a single opening for airflow and for insertion of the aerosol forming consumable, in which case the second insulator may be substantially cup-shaped. Alternatively the end of the second portion includes one or more holes to allow air to flow into the cavity.

Preferably, the heater is cup-shaped and defines a second portion of the cavity, the second portion comprising an end of the cavity. In this way the heater provides an end of the cavity for a received aerosol forming consumable to abut against. In this way the heater may have a closed end such that there is a single opening for airflow and for insertion of the aerosol forming consumable. Alternatively the end of the second portion includes one or more holes to enable airflow into the cavity.

Preferably, the end of the cavity comprises one or more holes to enable airflow into the cavity. As should be appreciated for the cup-shaped heater having one or more holes, the second insulator may have an opening, or even be substantially tube-shaped (i.e. a second sleeve) to air to reach the base of the heater cup.

Preferably, the outer wall of the second insulator comprises a metal such as stainless steel and/or a plastic such as polyether ether ketone, PEEK. It has been found that the external wall may comprise PEEK while offering sufficient insulation properties. Using PEEK as part of the external wall may preferably reduce the weight of the heating apparatus. If the external wall comprises PEEK, the PEEK may be a poorly thermally conducting form of PEEK.

Preferably, the heater is a resistance heater. In this way, a compact, simple and easy to power form of heater is provided. Alternatively, the heater could be an induction heater powered by a coil surrounding the second insulator.

Preferably, the heating apparatus comprises one or more wires configured to connect the heater to a power source. The one or more wires may be positioned through one or more gaps at a longitudinal end of the insulator sleeve (away from the opening) or at the interface between the insulator sleeve at the heater. For dual insulator arrangements, the wires may be positioned through one or more gaps between the first and second insulators. The one or more wires may be positioned through one or more gaps in the second insulator provided at a longitudinal end of the insulator toward the opening of the cavity (and at a longitudinal end of the first insulator away from the opening). In this way, the wires can have less contact with the insulator. This causes the wires to carry less heat out of the second insulator by conducting less heat from the walls of the second insulator. This configuration can also be simple to manufacture, thereby potentially reducing production costs. In one example, the wires have a single point of contact with the second insulator. The internal wall and the external wall may be connected by one or more seals provided around the wires and configured to prevent air from entering the second insulator and to hold the wires in place.

The wires can have a lower mass, which can be advantageous in terms of carrying weight for the user as well as for reducing the thermal mass of the device. One or more seals may be provided in the gaps to prevent air from entering the second insulator and to secure the wires in place. The gaps may be provided towards either end of the second insulator, or elsewhere on the external/outer wall of the second insulator.

According to another aspect of the invention, there is provided an aerosol generating device configured to generate an aerosol for inhalation by a user, comprising the heating apparatus according to the first aspect.

According to another aspect of the invention, there is provided an aerosol forming consumable for insertion into the heating apparatus according to the first aspect of the invention, the aerosol forming consumable comprising: a filter; an aerosol forming substance; and a wrapping material arranged to hold the filter and the aerosol forming substance so as to provide a predetermined gap between the filter and the aerosol forming substance.

### BRIEF DESCRIPTION OF DRAWINGS

Embodiments of the invention are now described, by way of example, with reference to the drawings, in which:

FIG. 1 is a perspective view of an aerosol generating device comprising a heating apparatus according to an embodiment of the invention;

FIG. 2 is a cross-sectional view of an aerosol forming consumable;

FIGS. 3A to 3D are cross-sectional schematic views of a heating apparatus;

FIGS. 4A and 4B are cross-sectional schematic views of a heating apparatus; and

FIGS. 5A and 5B are further schematics of the heating apparatus of FIG. 4.

### DETAILED DESCRIPTION

As described herein, a vapour is generally understood to refer to a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

In the below specific examples, the dual-walled insulators (i.e. the insulator sleeve and the second insulator) are described as vacuum insulators, where a vacuum is provided between the inner and outer walls of the respective insulator. However, it should be understood that the insulators described herein may not include a vacuum between the walls of the insulator and instead include an insulating material, such as aerogel, power or fibrous materials or even air.

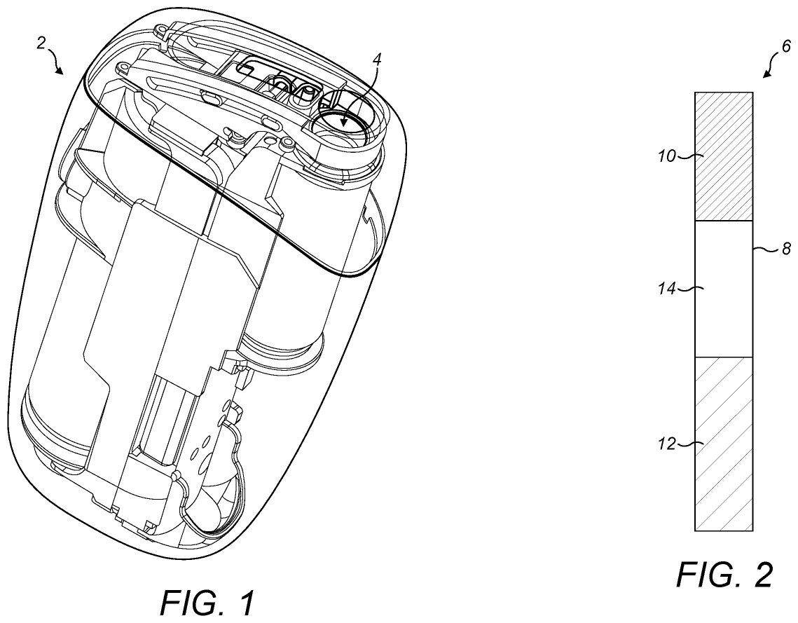

FIG. 1 illustrates an aerosol generating device 2 according to an embodiment of the invention. The aerosol generating device 2 is illustrated in an assembled configuration with exemplary internal components visible. The aerosol generating device 2 is a heat-not-burn device, which may also be referred to as a tobacco-vapour device, and comprises a heating apparatus 4 configured to receive an aerosol substrate such as a rod of aerosol generating material, e.g. tobacco. The aerosol generating device 2 may comprise a power source such as a battery and control circuitry for controlling the supply of power from the power source to the heating apparatus 4. The heating apparatus 4 is operable to heat, but not burn, the rod of aerosol generating material to produce a vapour or aerosol for inhalation by a user. Of course, the skilled person will appreciate that the aerosol generating device 2 depicted in FIG. 1 is simply an exemplary aerosol generating device according to the invention. Other types and configurations of tobacco-vapour products, vaporisers, or electronic cigarettes may also be used as the aerosol generating device according to the invention.

FIG. 2 shows a schematic view of an aerosol forming consumable 6 for insertion into the heating apparatus 4 of the aerosol generating device 2. The aerosol forming consumable 6 has a cylindrical body 8, in which is provided a filter 10 toward a first end and an aerosol forming substance 12 at a second end of the body 8. The aerosol forming substance 12 may be a solid or semi-solid aerosol forming substrate which comprises tobacco. Aerosol forming consumable 6 further includes an empty space 14 positioned in the body 8 between the filter 10 and the aerosol forming substance 12. This space 14 collects aerosol that is formed or generated from the aerosol forming substance 12 when it is heated, before the generated aerosol is inhaled by a user through the filter 10.

The aerosol forming consumable 6 also includes a wrapping material 16 which holds the filter 10 and aerosol forming substance 12 in place and provide the space 14 between the filter 10 and aerosol forming substance 12. The wrapping material 16 has suitable properties to ensure the integrity of the aerosol forming consumable 6, for example such that it does not crumple and collapse into the space 14 on insertion into a heating apparatus, or tear as the aerosol forming consumable is extracted from the heating apparatus. The space 14 may be formed a tubular member made of a stiff paper material, that provides a degree of rigidity whilst allowing generated aerosol to easily flow through the space 14 to the filter 10. The length of the aerosol forming substance 12 in the body 8 may be similar to the length in a longitudinal direction of the heating region in the present heating assembly.

As will be further explained later in reference to the heating assemblies in the present invention, the distribution of the aerosol forming substance 12 and the empty space 14 in the consumable 6 is selected to match, or be suitable, for a corresponding heating region and insulating region respectively in order to optimise the heating efficiency and reduce undesired heat loss of the heating apparatus 4. For example, the top end of the aerosol forming substance 12 can be positioned at the same level in the longitudinal direction as the top end of the heating region, when the aerosol forming consumable 6 is inserted into aerosol generating device 2. However, the top end of the aerosol forming substance 12 can be positioned at a higher or lower level than the top end of the heating region, to adjust a balance between the heating efficiency and the amount of vapour generation, etc.

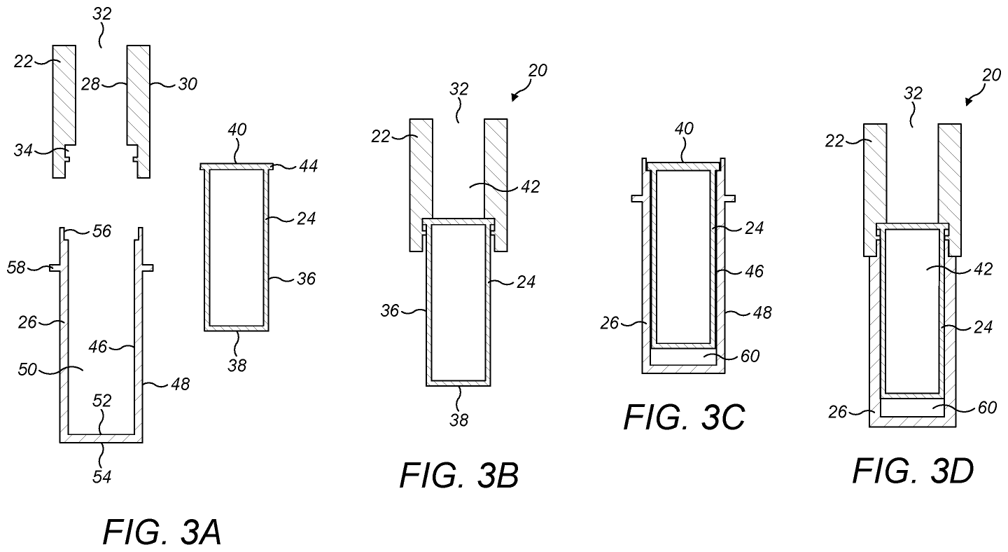

FIGS. 3A to 3D show different cross-sectional arrangements of a heating apparatus 20 having a heater region and an insulating passage according to the present disclosure. FIG. 3A shows an exploded view of a vacuum insulator sleeve 22, a heater cup 24 and a vacuum insulator cup 26, and FIGS. 3B to 3D illustrate different combinations of the vacuum sleeve 22, heater cup 24 and/or vacuum cup 26. Some of the insulators in the specific examples in FIGS. 3A to 5B have been described with a vacuum provided between the inner and outer walls of the insulator cup and the insulator sleeve(s). However, it will be appreciated that the vacuum in either of the insulators, or even both, may be replaced with other insulating mediums/materials, such as air, aerogel materials, powders or fibrous insulating materials.

The vacuum insulator sleeve 22 has an inner wall 28 and an outerwall 30 between which a vacuum is enclosed. The skilled person will understand that the term “vacuum” refers to a space in which the pressure is considerably lower than atmospheric pressure due to the removal of free matter, in particular air. The quality of the vacuum formed between the inner wall 28 and the outer wall 30 may be a low vacuum, a medium vacuum, or a high vacuum.

The inner wall 28 and the outer wall 30 are spaced radially apart from one another to define an enclosed space between them in which a vacuum is formed. In the present example, the inner wall 28 and outer wall 30 form concentric cylinders which are coupled at both ends of the vacuum sleeve.

The vacuum sleeve 22 is hollow and defines a longitudinal axis between a first end and a second end, where an aerosol forming consumable 6 can be received through an opening 32 at the first end and pass out through the second end. In other words, the vacuum sleeve 22 provides a tunnel through which an aerosol forming consumable 6 can pass in a supported way. The opening 32 acts as the access point for insertion of a consumable 6 into the heating apparatus 20 in its constructed form.

The vacuum sleeve 22 has an approximately elliptical or circular cross-section when viewed along one of its ends, parallel to its longitudinal axis. In the present example, the vacuum sleeve 22 has a substantially circular cross-sectional shape. However, in alternative examples, the vacuum sleeve 22 may also be formed in other types of cross-sectional shape, for example shapes that are approximately square or polygonal.

The vacuum insulator sleeve 22 also includes grooves 34 for connection with the heater cup 24, as shown in FIGS. 3B and 3D. The connection may be by push-fit, where the grooves 34 are made of a plastic or otherwise flexible material to allow a lip of the heater cup 24 to be clicked in place. Alternatively the grooves 34 may be of a screw-fit connection, in which the lip of the heater cup 24 can be screwed.

FIG. 3B shows the vacuum insulator sleeve 22 arranged over the heater cup 24. The heater cup 24 is cup-shaped having walls 36, a base 38 and an opening 40 in which the aerosol forming consumable 6 is received. A cavity 42 is defined when the heater cup 24 is connected to the vacuum insulator sleeve 22, where the opening 32 of the sleeve 22 is where a consumable 6 is inserted, and the base 38 of the heater cup 24 is the closed end of the cavity 42 which the inserted consumable 6 abuts against. In this example, the inner surfaces of the heater cup walls 36 and the inner wall 28 of the vacuum sleeve 22 are substantially in line with each other such that the consumable 6 can be inserted into the cavity 42 with ease. As will be apparent to the skilled person, the inner surfaces may be tapered, textured or have ridges to control the degree and depth of contact between walls and the consumable. The heater cup 24 may be a resistive heater, or alternatively be made of an inductive material.

The heater cup 24 further includes a lip 44 arranged toward the opening 40 of the heater cup 24 for attaching to the grooves 34 of the vacuum sleeve 22, as described above. The attachment of the vacuum sleeve 22 to the opening 40 of the heater cup 24 prevents heat from the heater cup 24 from conducting outside of the heating apparatus and device. To optimise the effectiveness and efficiency of the heating apparatus, the length of the aerosol forming substance 12 in the aerosol forming consumable 6 should be substantially the same as (or slightly greater than) the length of the cavity 42 surrounded by the heater cup 24. This means that heat is only emitted from the heater cup 24 to the aerosol forming substance section of an inserted consumable. The length of the space 14 in an aerosol forming consumable does not necessarily have to correspond with the length of the cavity 42 surrounded by vacuum insulator sleeve 22. The relative lengths of the filter 10, space 14 and aerosol forming substance 12 in an aerosol forming consumable 6 that is suitable for a heating apparatus according to the present disclosure will be readily apparent to the skilled person.

FIG. 3C illustrates the heater cup 24 arranged in a vacuum insulator cup 26. The vacuum insulator cup 26 has an inner wall 46 and an outer wall 48 between which a vacuum is enclosed. In this specific example, the heater cup 24 is configured to be inserted into a chamber 50 defined by the outer surface of the inner wall 46 of the vacuum insulator cup 26. The inner wall 46 of the vacuum insulator cup 26 is tubular, e.g. substantially cylindrical, to match the outer surface of the heater cup 24, and has an outer (e.g. circumferential) surface and an inner (e.g. circumferential) surface. The outer wall 48 is tubular, e.g. substantially cylindrical, and has an outer (e.g. circumferential) surface and an inner (e.g. circumferential) surface. The inner wall 46 and outer wall 48 further each further comprise a base portion 52, 54 to provide the cup shape.

In an alternative example, not shown, a heater trace may be provided instead of the heater cup 24, where the trace may be arranged on the inner surface of the inner wall 46 of the vacuum insulator cup 26 such that the inner surface of the inner wall 46 defines a portion of the cavity 42 of the heater apparatus 20. As will be appreciated, in this alternative example the cavity is thus defined by the inner surfaces of the inner walls of a vacuum insulator sleeve and a vacuum insulator cup.

The vacuum insulator cup 26 provides thermal insulation for the heater cup 24 to minimise the amount of heat that reaches external surfaces of the device. It should be appreciated that the cross-sectional shape of the vacuum insulator cup 26 will be selected to match with the vacuum sleeve 22 and/or heater cup 24 according to design requirements. As seen most clearly in FIG. 3A, the vacuum insulator cup 26 includes an inner ridge portion 56 on which the lip 44 of the heater cup 24 can rest on, and an outer ledge 58 for adjoining to second end of the vacuum sleeve 22.

A fully constructed dual vacuum heating apparatus is shown in FIG. 3D. As can be seen in FIGS. 3C and 3D, a void 60 is provided between the outer surface of the base 38 of the heater cup 24, and the inner surface of the inner wall 46 of the vacuum insulator cup 26. One or more holes, not shown, may be provided in the walls or base of the heater cup 24 and/or vacuum insulator cup 26 surrounding the void 60 to improve airflow from the aerosol forming substance end of an inserted consumable.

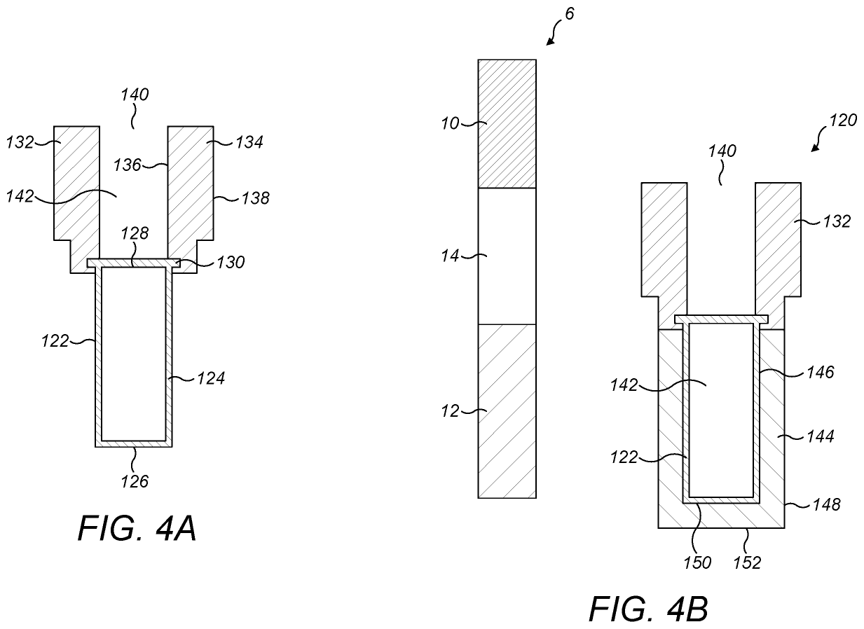

FIGS. 4A and 4B show different cross-sectional arrangements of another heating apparatus 120 having a heating region and a different type of insulating passage according to the present disclosure. FIGS. 4A and 4B show a heater cup 122 similar to that described in reference to FIGS. 3A to 3D, where the heater cup 122 is cup-shaped having walls 124, a base 126 and an opening 128 in which the aerosol forming consumable 6 is received. The heater cup 122 also includes a lip 130 for attaching to an insulator sleeve or resting in an insulator cup as described in reference to FIG. 3.

The length of the heater cup 122 is made to be substantially the same as (or slightly less than) the length of the aerosol forming substance section of a consumable 6 specially designed for the heating apparatus 120, in order to optimise the effectiveness and efficiency of the heating apparatus 120. In this way heat is only emitted from the heater cup 122 to the aerosol forming substance section of an inserted consumable.

The heating apparatus 120 further includes an insulator sleeve 132 comprising insulation material 134, such as aerogel sheets or superwool sheets. The insulation material 134 may be shaped into a hollow cylinder to define an inner surface 136 and an outer surface 138. Alternatively the insulation material 134 may be encased in a casing material having low thermal conductivity.

The insulator sleeve 132 defines a longitudinal axis between a first end and a second end, where an aerosol forming consumable 6 can be received through an opening 140 at the first end and pass out through the second end. The insulator sleeve 132 thus provides a tunnel through which an aerosol forming consumable 6 can be supported. The opening 140 acts as the access point for insertion of a consumable 6 into the heating apparatus 120 in its constructed form.

The insulator sleeve 132 has an approximately elliptical or circular cross-section when viewed along one of its ends, parallel to its longitudinal axis. In the present example, the insulator sleeve 132 has a substantially circular cross-sectional shape. However, in alternative examples, the insulator sleeve 132 may also be formed in other types of cross-sectional shape, for example shapes that are approximately square or polygonal.

The insulator sleeve 132 may be attached to the heater cup 122 in various ways. In one example, the insulation material 134 may be wrapped around the upper end of the heater cup 122, including the heater cup lip 130, to form the sleeve 132. In other example, the lip 130 may tap into the insulation material 134 as it is screwed into the insulation material 134. In yet another example, the insulator sleeve 132 has grooves in a casing material which allows a push-fit or screw connection with the heater cup 122.

A cavity 142 is defined when the heater cup 122 is connected to the insulator sleeve 132, where the opening 140 of the sleeve 132 is the opening of the cavity 142, and the base 38 of the heater cup 126 is the closed end of the cavity 142. In this example, the inner surfaces of the heater cup walls 124 and the inner wall of the sleeve 132 are substantially in line with each other such that the consumable 6 can be smoothly inserted into the cavity 142. As will be apparent to the skilled person, the inner surfaces may be tapered, textured or have ridges to control the degree and depth of contact between walls and the consumable. The heater cup 122 may be a resistive heater, or alternatively be made of an inductive material.

The length of the space 14 in an aerosol forming consumable is similar to the length of the cavity 142 surrounded by insulator sleeve 132. However it should be understood that this does not have to be the case, and the length of the space 14 may be shorter than the cavity 142 surrounded by the sleeve 132 (e.g. where the filter 10 descends in to the cavity 142). The relative lengths of the filter 10, space 14 and aerosol forming substance 12 in an aerosol forming consumable 6 that is suitable for a heating apparatus according to the present disclosure will be readily apparent to the skilled person.

As seen in FIG. 4B the heater cup 122 is positioned in a vacuum insulator cup 144, similar to the vacuum insulator cup 26 described in FIG. 3. The vacuum insulator cup 144 provides insulation for the heater cup 122.

The vacuum insulator cup 144 has an inner wall 146 and an outer wall 148 between which a vacuum is enclosed. The inner wall 46 and outer wall 48 further each further comprise a base portion 150, 152 to provide the cup shape.

It should be appreciated that the cross-sectional shape of the vacuum insulator cup 144 will be selected to match with the insulator sleeve 132 and/or heater cup 122 according to design requirements. The interface between the insulator sleeve 132 and the vacuum insulator cup 144 may be a fitted connection, such as push-fit or screw-fit connection, or may rest against each other, or even leave a gap therebetween.

In an alternative example, not shown, a heater trace can be provided instead of the heater cup 122, where the trace may be arranged on the inner surface of the inner wall 146 of the vacuum insulator cup 144 such that the inner surface of the inner wall 146 defines a portion of the cavity 142 of the heater apparatus 120. As will be appreciated, in this alternative example the cavity is thus defined by the inner surfaces of the inner walls of a vacuum insulator sleeve and a vacuum insulator cup.

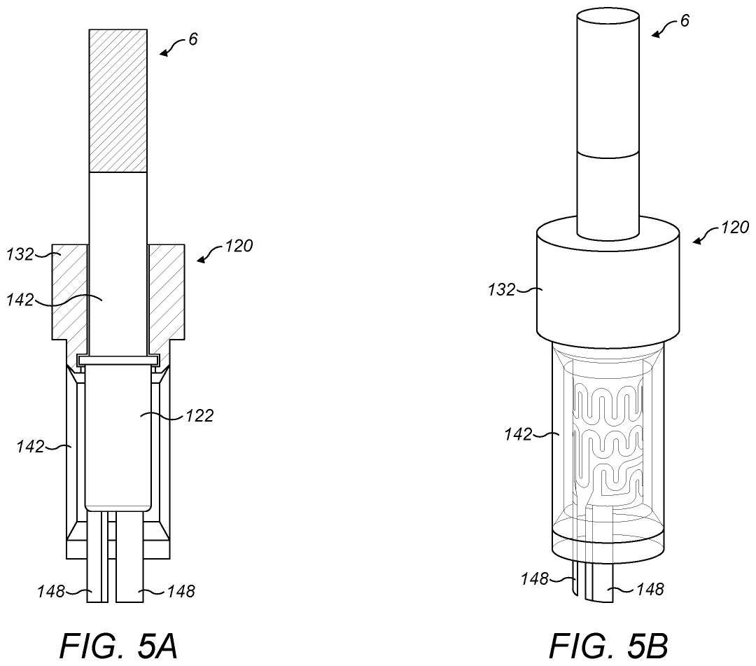

FIGS. 5A and 5B show further schematic views of the heating apparatus 120 of FIG. 4 with an aerosol forming consumable 6 inserted within the cavity 142. As can be seen in these specific examples, the length of the space 14 in the consumable 6 is greater than the length of the insulator sleeve 132. It can also be seen that the aerosol forming substance section is entirely within the heater cup 122 section of the apparatus 120.

FIGS. 5A and 5B show wires 148 that connect the heater cup 122 (or a heater trace) to a power source (not shown). As such the base of the vacuum insulator cup 144 contains one or more apertures to allow the wires 148 to pass through the cup 122 from the cavity 142. In another example, not shown, the vacuum insulator cup 144 surrounding the heater cup 122 may be replaced with a vacuum insulator sleeve (i.e. a hollow cylinder without a base) to simplify manufacturing. In yet another example, the wires 148 may be routed out of the cavity 142 at the interface between the insulator sleeve 132 and the vacuum insulator cup 144, where one or more apertures (or a full circumferential gap) is provided at the interface for the wires 148 to pass between a power source and the heater cup 122.

1. A heating apparatus for an aerosol generating device, comprising:
a cavity having a main longitudinal axis and comprising an opening in which an aerosol forming substance can be received;
a first insulator sleeve comprising an inner wall and an outer wall, where the inner wall is radially proximal to the cavity, the first insulator sleeve arranged along a first portion of the cavity with respect to the main longitudinal axis;
a second insulator comprising an inner wall and an outer wall, where the inner wall of the second insulator is radially proximal to the cavity, the second insulator arranged along a second portion of the cavity, wherein the second portion is positioned distally to the opening with respect to the first insulator sleeve along the main longitudinal axis; and
a heater positioned radially inwardly with respect to the outer wall of the second insulator and configured to provide heat to an aerosol forming substance received in the cavity.

2. The heating apparatus of claim 1, wherein the first insulator sleeve and/or the second insulator comprises a vacuum between the respective inner and outer walls.

3. The heating apparatus of claim 1, wherein the first insulator sleeve and/or the second insulator comprises an insulating material between the respective inner and outer walls.

4. The heating apparatus of claim 1, wherein the first insulator sleeve comprises a length of at least 3 millimetres along the main longitudinal axis.

5. The heating apparatus of claim 1, wherein the heater is arranged on the inner wall of the second insulator, between the outer and inner walls of the second insulator.

6. The heating apparatus of claim 5, further comprising an electrical insulation layer provided between the heater and the inner wall of the second insulator.

7. The heating apparatus of claim 1, wherein the second insulator comprises an end of the cavity.

8. The heating apparatus of claim 1, wherein the heater is cup-shaped and comprises an end of the cavity.

9. The heating apparatus of claim 7, wherein the end of the cavity comprises one or more holes to enable airflow into the cavity.

10. The heating apparatus of claim 1, wherein the outer wall of the second insulator comprises a metal and/or a plastic.

11. The heating apparatus of claim 1, wherein the heater is a resistance heater.

12. The heating apparatus of claim 1, further comprising one or more wires configured to connect the heater to a power source.

13. An aerosol generating device configured to generate an aerosol for inhalation by a user, comprising the heating apparatus of claim 1.

14. An aerosol forming consumable for insertion into the heating apparatus according to claim 1, comprising:
a filter;
an aerosol forming substance; and
a wrapping material arranged to hold the filter and the aerosol forming substance so as to provide a predetermined gap between the filter and the aerosol forming substance.

15. The heating apparatus of claim 1, wherein the outer wall of the second insulator comprises stainless steel and/or polyether ether ketone, PEEK.
